(19) United States
(12) Patent Application Publication
(10) Pub. No.: US 2013/0329927 A1
(43) Pub. Date: Dec. 12, 2013

(54) AUDIO ENHANCEMENT DEVICE

(71) Applicant: Vipula Vijayanthe SAMARAKOON, Singapore (SG)

(72) Inventor: Vipula Vijayanthe SAMARAKOON, Singapore (SG)

(21) Appl. No.: 13/915,196

(22) Filed: Jun. 11, 2013

(30) Foreign Application Priority Data
Jun. 11, 2012 (SG) 201204310-5

(51) Int. Cl. H04R 1/02

(52) U.S. Cl. CPC H04R 1/025
USPC 381/333

(57) ABSTRACT

In one embodiment, an audio enhancement device includes a sidewall and a pair of end walls extending laterally from the sidewall. The sidewall includes a first side edge and a second side edge. Each of the end walls includes a first endwall edge and a second endwall edge. The first sidewall edge and the first endwall edges form a first interface. and the second sidewall edge and the second endwall edges form a second interface. A fixing means is provided on the first interface for attaching the device to an audio source such as a multimedia monitor. The first and second interfaces face different directions. When being attached to the audio source, the device receives audio waves from the audio source through the first interface, reflects the audio waves towards the second interface, and to output the audio waves from the second interface.

### TECHNICAL FIELD

The present invention relates to an audio enhancement device that improves users' experience of using a multimedia system.

### BACKGROUND

Multimedia systems are widely used nowadays that provide users with information in audio and visual form. One of these systems is a computer monitor with built-in speakers. Such a monitor presents visual information such as texts and visual from the display screen as well as audio signals from the speakers. As under normal use circumstances computer monitors serve the primary function of displaying visual information, the speakers have been designed with compact size concerning the limited desk space available for a computer monitor. While a monitor with built-in speakers are meant for providing users with multimedia experiences, it is not always easy to provide a monitor which is compact in size, but with without compromising the quality of audio signals. FIG. 1 shows one type of multimedia monitor that has these constraints.

As shown in FIG. 1, monitor 10 has a main front surface 12 with a display screen 14 occupying a majority part thereof. At bottom edge 16 of monitor 10 there are formed arrays of down-facing apertures 18 which serve to allow audio wave to pass through from speakers in monitor 10. While arranging the audio wave output from the monitor along a down-facing direction may be helpful to keep the external shape of the monitor slim, the quality of sound provided by such monitor us unsatisfactory, as a user sitting in front of display screen 14 can only receive the audio wave in an indirect manner. There are other types of multimedia monitors with audio wave supplying directly facing the user. However, these monitors have other drawbacks e.g. either the monitor body is bulky, or the area on the front surface available for the display screen is reduced, in order to accommodate front-facing speakers.

It is therefore desirable to improve the audio signal quality for the type of monitors with down-facing audio output without substantially affecting the original external shape of the monitor.

### SUMMARY

Embodiments of the present invention provide a device which is attachable to a multimedia monitor to enhance the audio effect and improves the user experiences of receiving audio signals. In one embodiment, an audio enhancement device includes a sidewall and a pair of end walls extending laterally from the sidewall. The sidewall includes a first side edge and a second side edge. Each of the end walls includes a first endwall edge and a second endwall edge. The first sidewall edge and the first endwall edges form a first interface, and the second sidewall edge and the second endwall edges form a second interface. A fixing means is provided on the first interface for attaching the device to an audio source such as a multimedia monitor. The first and second interfaces face different directions. When being attached to the audio source, the device receives audio waves from the audio source through the first interface, reflects the audio waves towards the second interface, and to output the audio waves from the second interface.

Other aspects and advantages of the present invention will become apparent from the following detailed description, illustrating by way of example the inventive concept of the present invention.

### BRIEF DESCRIPTION OF THE DRAWINGS

Embodiments of the invention are disclosed hereinafter with reference to the drawings, in which:

FIG. 1 is a partial perspective view showing a multimedia monitor;

FIG. 2 is a perspective view showing one embodiment of the present invention;

FIG. 3 is a perspective view showing a multimedia monitor of Fig. I and a pair of audio enhancement devices of FIG. 2 attached to the monitor;

FIG. 4 is an exploded perspective view of FIG. 3;

FIG. 5 is an enlarged partial view of FIG. 4;

FIG. 6 is an enlarged partial view of FIG. 3;

FIG. 7 is a partial cross-sectional side view of FIG. 6;

FIG. 8 is a perspective view showing another embodiment of the present invention;

FIG. 9 is a perspective view of FIG. 8 in an assembled status;

FIG. 10 is a perspective view showing yet another embodiment of the present invention;

FIG. 11 is a perspective view showing a further embodiment of the present invention.

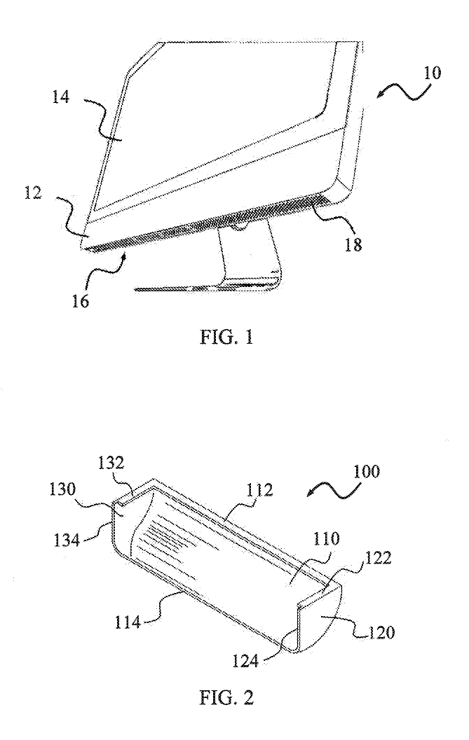

### DETAILED DESCRIPTION OF PREFERRED EMBODIMENTS

As shown in FIG. 2, an audio enhancement device 100 according to one embodiment of the present invention has a sidewall 110, formed of metal or hard plastic for instance, which is capable of reflecting audio waves. A pair of endwalls 120, 130 extend laterally from sidewall 110. Endwalls 120 and 130 may be made by same material as, an integral to, sidewall 110, by die-casting, stamping, molding or the like. Sidewall 110 has a first sidewall edge 112 and a second sidewall edge 114. Endwalls 120 and 130 each has a respective first endwall edge 122, 132 and a second endwall edge 124, 134. First sidewall edge 112 and first endwall edges 122, 132 form a first interface 102.

Second sidewall edge 114 and second endwall edges 124, 134 form a second interface 104. First and second interfaces 102 and 104 face different direction. Sidewall 110 may be a curved or flat surface, and is arranged in a slanted manner such that sidewall 110 faces both the first and second interfaces 102 and 104.

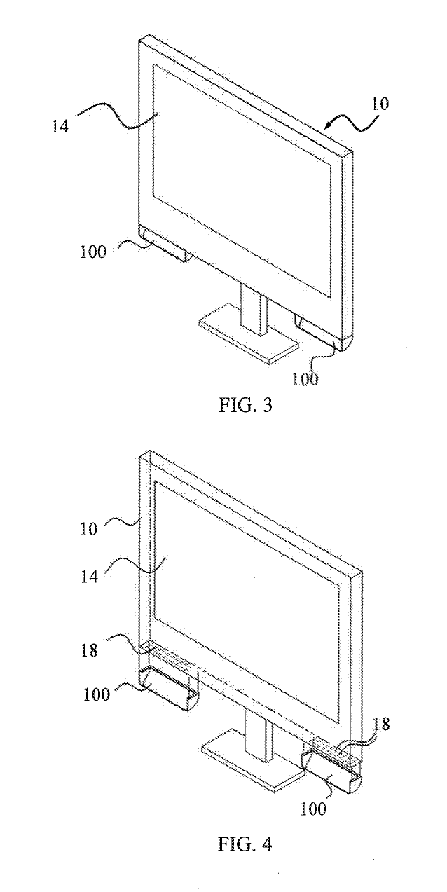

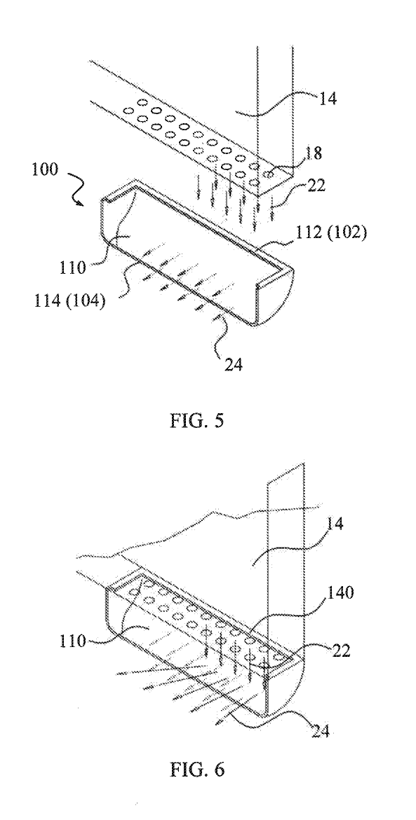

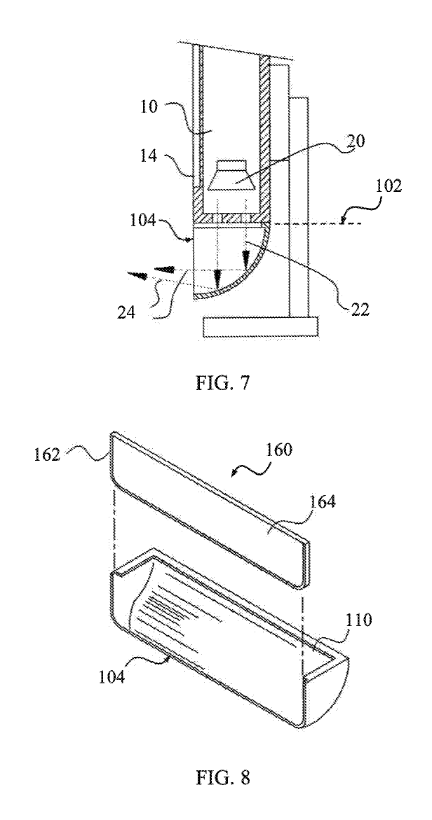

Fixing means, e.g. a double-sided tape 140 may be attached to first interface 102. In use, as shown in FIGS. 3 and 4, one or more audio enhancement device 100 is attached to a multimedia monitor 10, with first interface 102 coupled to down-facing sound output port 18 of monitor 10. Double-sided tape 140 serves to fix audio enhancement device 100 to monitor 10. Alternatively, audio enhancement device 100 may be attached to monitor 10 by other ways, e.g. adhesives, magnets, screws, etc. When enhancement device 100 is fixed to monitor 10 in this manner, second interface 104 faces the same direction as that of the display screen 14 of monitor 10, as shown in FIGS. 5, 6 and 7.

Audio waves from the built-in audio system of monitor 10, e.g. a speaker 20, will pass through ports 18 from monitor 10 along down-facing direction 22. Received by audio enhancement device 100 through first interface 102, audio waves along down-facing direction 22 will arrive at sidewall 110 and due the audio-reflective nature of sidewall 110, audio waves along down-facing direction 22, or at least a major part thereof, will change the direction of propagation and be directed towards and emit from, second interface 104 along a front-facing direction 24 towards a user (not shown) sitting in front of monitor 10.

Accordingly, audio enhancement device 100 changes the path that the audio wave propagates, from its original down-facing direction 22 to the front-facing direction 24 and is directly received by the user. The user experiences of the audio quality is therefore enhanced and improved.

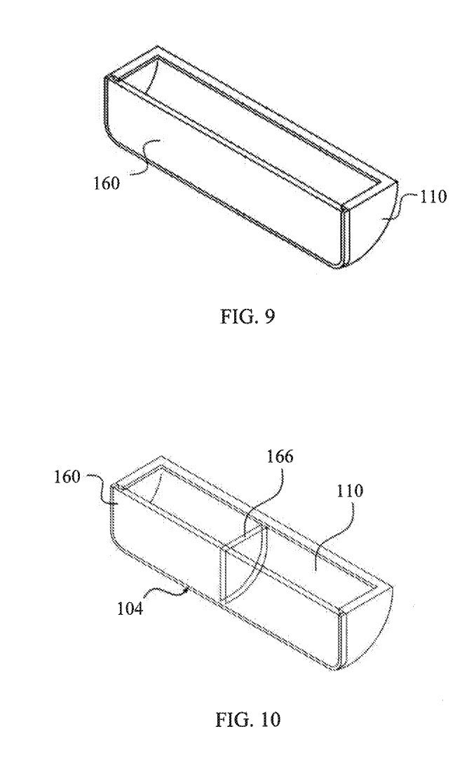

In another embodiment as shown in FIGS. 8 and 9, audio enhancement device 100 may include a front cover 160 which can be attached to second interface 104. Front cover 160 may include a rigid frame 162 and a face material 164 supported by the frame. Face material 164 may be of the type that allows audio waves to pass through, e.g. textiles. Front cover 160 prevents direct visual exposure of the inner side of audio enhancement device 100, hence is helpful to improve the external appearance of audio enhancement device 100 and may also serve as a dust cover.

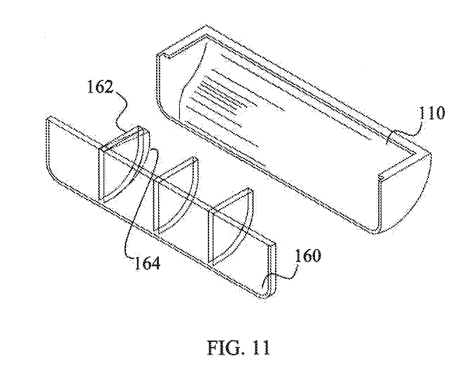

In further embodiments as shown in FIGS. 10 and 11, front cover 160 may include one or more fins 166 which extend towards sidewall 110. Fin 166 may be made of rigid material, e.g. metal or hard plastic which improves the attachment reliability of front cover 160 to second interface 104 and sidewall 110. Additionally, fin 162 may also serve as an audio wave divider inside audio enhancement device 100. Fin 162 may be fixed to front cover 160 or alternatively, fin 162 may be movably attached to front cover 160 such that the actual position of fin 162 may vary and adjustable by the user. In one embodiment as shown in FIG. 11, the position of fin 162 is changed from a position perpendicular to front cover 160, to one which is angled relative to front cover 160, as depicted by 164 in FIG. 11. Variation of the position and angle of the fin relative to front cover may have the effect of directing the output audio wave in a slight different angle, hence to provide the user with different sound-receiving experience.

As illustrated hereinabove, audio enhancement device according to embodiments of the present invention provide a simple, low-cost yet effective solution to improve and enhance the users audio-receiving experiences by using existing multimedia monitors without the need of modification.

Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. An audio enhancement device comprising:
a sidewall and a pair of end walls extending laterally from the sidewall, the sidewall including a first side edge and a second side edge, each of the end walls including a first endwall edge and a second endwall edge,
wherein the first sidewall edge and the first endwall edges form a first interface,
wherein the second sidewall edge and the second endwall edges form a second interface,
a fixing means provided on the first interface for attaching the device to an audio source;
wherein the first and second interfaces face different directions, and
wherein when being attached to the audio source, the device is to receive audio waves from the audio source through the first interface, reflect the audio waves towards the second interface, and to output the audio waves from the second interface.

2. The audio enhancement device of claim 1, further comprising a front cover coupled to the second interface, wherein the front cover is to allow the audio waves to pass through.

3. The audio enhancement device of claim 2, wherein the front cover further comprising at least one support fin extending towards the sidewall.

4. The audio enhancement device of claim 3, wherein the at least one support fin is fixedly attached to the front cover.

5. The audio enhancement device of claim 3, wherein the at least one support fin is movably attached to the front cover.
